(19) United States
(12) Patent Application Publication
(10) Pub. No.: US 2004/0113724 A1
(43) Pub. Date: Jun. 17, 2004

(54) Integrated and tunable high quality resonant circuit based on transmission lines

(75) Inventor: David H. Shen, Saratoga, CA (US)

Correspondence Address: DAVID H. SHEN, IRF Semiconductor, Inc., 6 RESULTS WAY, CUPERTINO, CA, 95014, US

(73) Assignee: IRF SEMICONDUCTOR, INC.

(21) Appl. No.: 10/729,344

(22) Filed: Dec. 5, 2003

Related U.S. Application Data
(60) Provisional application No. 60/431,968, filed on Dec. 10, 2002.

(51) Int. Cl. H01P 7/00

(52) U.S. Cl. 333/219

(57) ABSTRACT

A high quality resonant circuit that can easily be integrated into an integrated circuit package or substrate is disclosed. The resonant circuit is based on a transmission line impedance transformation property, which allows the resonant circuit to have higher quality factor than existing integrated L-C implementations.

THIS APPLICATION IS BASED ON THE PROVISIONAL APPLICATION No. 60/431,968 FILED ON Dec. 10, 2002

### REFERENCES

[1] D. Leenaerts et al., Circuit Design for RF Transceivers, pp. 37-42, Kluwer Academic Publishers, Boston, 2001.

[2] D. Pozar, Microwave Engineering, pp. 92-93,1990 Addison-Wesley Publishing Company, Inc., 9/1993 Reprint.

### BACKGROUND

1. Technical Field of Invention

This present invention relates to a high quality resonant circuit inside a packaged semiconductor integrated circuit that can be used for integrated systems requiring high quality resonant circuits such as filtering in radio frequency (RF) systems and high speed filtering for electrical and optical channels.

2. Background of the Invention and Discussion of Prior Art

High quality on-chip filtering has always been a challenge for circuit designers. Recent improvements in semiconductor processing have allowed inductors to be integrated onto semiconductor substrates using the top metal layers of the process, as shown in FIG. 1 [1]. The inductor consists of a terminal, 1, in top level metal, a terminal, 2, with a via to top-1 level metal, and a spiral, 3, consisting of top level metal. In addition, the recent use of copper and extra thick metal for the spiral, 3, has improved the quality factor, Q, of inductors to the range of 10-20. The quality factor Q is a measure of a resonant circuit as well known in the art. The use of an on chip L-C tank with the C as a tunable varactor typically allows a tuning range of about 20-30% of the center frequency. However, the Q value of the typical off-chip discrete components is in the range of 100 to more than 10,000. Therefore, the low quality factor Q and limited tuning range of the L-C resonant circuit make it unattractive for on-chip filtering in many applications.

### OBJECTS AND ADVANTAGES OF THE INVENTION

Accordingly, it is a primary object of the present invention to provide an integrated implementation of a resonant circuit with a quality factor and tuning range that exceed the prior art. An additional advantage is that the present invention can run up to higher frequencies than the prior art, since the on-chip inductors of the prior art has limitations on maximum operating frequency due to the stray parasitic capacitances and resistances associated with the inductor structure. A further advantage of the present invention is that it is not as susceptible to parasitic inductive coupling with other resonant circuits on the chip as the prior art.

### SUMMARY OF THE INVENTION

The present invention achieves the above objectives and advantages by taking advantage of the properties of transmission lines. Transmission line properties are well known in the prior art. One of the properties of a transmission line is its ability to transform impedance. By taking advantage of the impedance transforming properties of a transmission line, a high quality resonator with superior performance compared to the prior art can be implemented.

### DESCRIPTION OF DRAWINGS

FIG. 1 is a drawing of an integrated inductor considered as prior art.

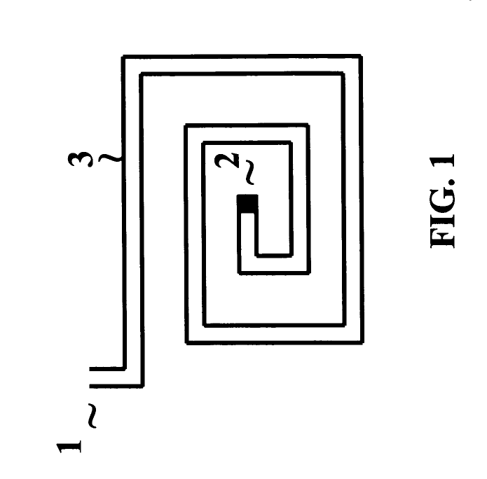

FIG. 2 is a drawing of a transmission line with ability to transform impedance.

FIG. 3 is a drawing of a resonant circuit schematic constructed according to the principles of the invention

FIG. 4 is a plot of a calculated frequency response using the invention.

FIG. 5 is a drawing of a tunable resonant circuit constructed according to the principles of the invention.

### DESCRIPTION OF THE PREFERRED EMBODIMENT

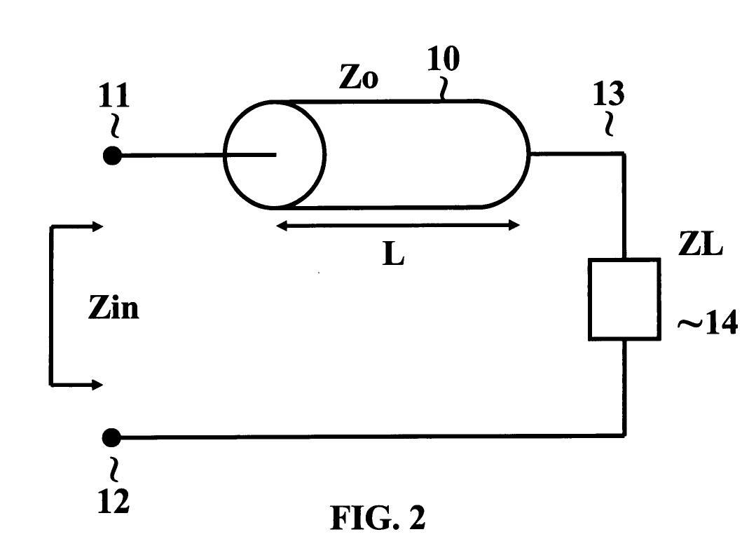

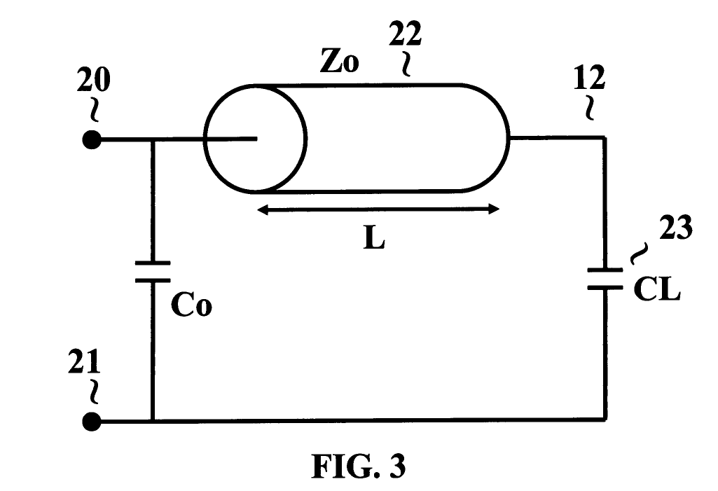

A transmission line schematic is shown in FIG. 2. The schematic contains a transmission line, 10, two input terminals, 11 and 12, a load terminal, 13, and a load impedance, 14. The transmission line, 10, has characteristic impedance denoted by the symbol, Zo, and a length, L. The load impedance, 14, has impedance value ZL. The equivalent input impedance of the transmission line is denoted by symbol Zin. As is well known in the art, an ideal transmission line transforms the load impedance, 14, so that the input impedance of the line is Zin=Zo*(ZL+j*Zo*tan(b*L))/(Zo+j*ZL*tan(b*L)), where j is sqrt(−1), tan is the tangent function, b is the propagation constant of the transmission line [2]. The inventor notes that this function can be used to transform a high quality capacitor (a capacitor with low parasitic series resistance) to a high quality inductor when the wavelength of the input signal is exactly four times the length of the transmission line. By implementing the transmission line in the metal layers above a semiconductor substrate, it is possible to build a high quality effective inductor at a single frequency. This inductor can have superior Q characteristic to the prior art. The transmission line can also be implemented on a package substrate with an improved quality factor since the package transmission line resistive loss will tend to be lower than an on-chip transmission line resistive loss. The transmission line built on the package substrate is preferred when the on-chip transmission line proves to be too area consuming, which can be the case for low frequencies (below 1 GHz). FIG. 3 shows the preferred embodiment of the invention: resonant filter circuit schematic with input terminals, 20 and 21, a transmission line of characteristic impedance Zo, 22, a load capacitance, 23, and a parallel capacitor, 24. The load capacitance, 23, has capacitance value CL, and the parallel capacitor, 24, has capacitance value Co. The resonant circuit is tuned to its highest quality point when the transmission line length, L, is tuned to one quarter the wavelength, lambda/4, of the resonant frequency, fo. In this case, the transmission line transforms the capacitor, 23, into an equivalent inductor of value Zo\hat{ }2*CL. A high quality resonant peak is obtained by tuning the values of Co and CL such that 2*pi*fo=1/sqrt(Co*CL*Zo\hat{ }2).

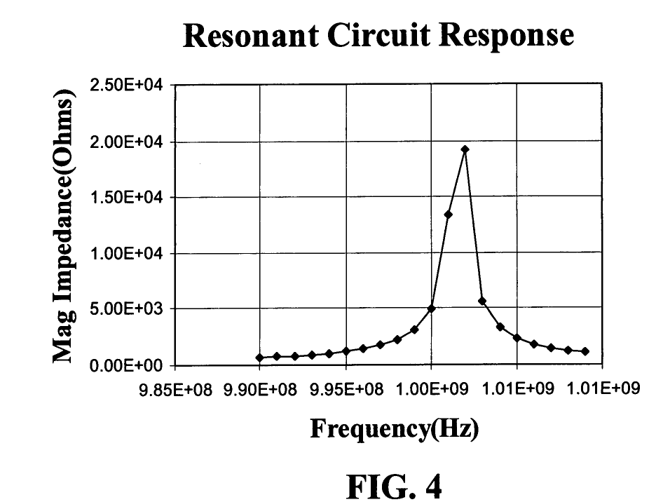

In FIG. 4, a plot of the calculated resonant peak tuned to 1 GHz using the invention is shown. The peak shows extremely good quality factor. In FIG. 4, the value of load impedance, CL, is 10 pF, the value of parallel capacitance, Co, is 1 pF, and the value of the characteristic impedance, Zo is 50 ohms. These values are all reasonable to be incorporated on a semiconductor substrate or package substrate using known techniques in the art.

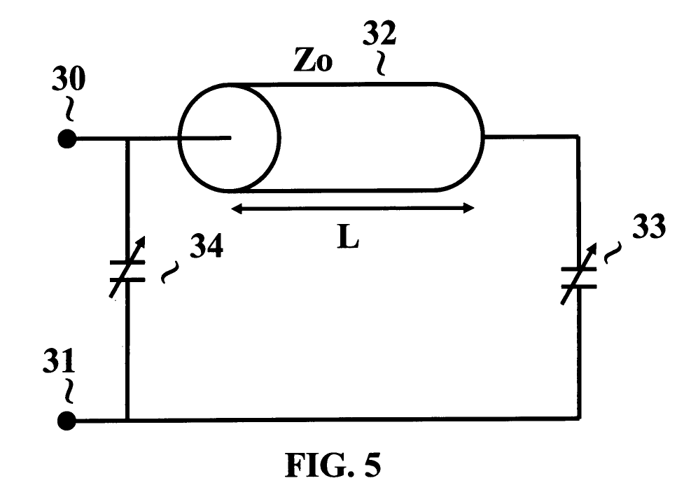

FIG. 5 gives an alternative embodiment of the invention where the resonant circuit can be tuned. The tunable resonant circuit consists of input terminals, 30 and 31, transmission line, 32, and tunable capacitors, 33 and 34. Both capacitors, 33 and 34, can be implemented as varactors, which can be tuned. In order for the transmission line impedance transformation to give the proper transformation at different frequencies, the impedance transforming repeats every (n*lambda+lambda/4) wavelengths, where n is an integer. Thus, the resonant filter is only tunable near frequencies that satisfy the impedance transforming property. Compared to the prior art, there are advantages. The main advantage of the invention is that both varactors, 33 and 34, can be tuned, thereby extending the tunable range compared to the prior art. In addition, high quality filtering can be retained. However, the tuning range must include frequencies that satisfy the impedance transforming property of the inductor.

Those skilled in the art will also recognize that the invention does not depend on the type of transmission line, or if it is implemented on the chip substrate, the package substrate, or the printed circuit board. Those skilled in the art will also recognize that there are many possible values of transmission line characteristic impedance Zo, load impedance CL, and parallel capacitance Co that are possible, and that all possible values are covered by the patent. Those skilled in the art will also recognize that there are many possible applications of resonant circuits and that this invention is not limited to one particular application. Accordingly, the scope of the invention should be determined not by the embodiment described, but by the appended claims and their legal equivalents.

1. A method for implementing a resonant circuit comprising of an input signal connected to the input of a transmission line. The output of the transmission line is connected to a capacitive load. The input signal is also connected to a parallel capacitive load.

2. The method of claim 1 wherein the transmission line is implemented off-chip.

3. The method of claim 1 wherein the transmission line is implemented on a silicon or other semiconductor substrate.

4. The method of claim 1 wherein the transmission line is implemented on the package substrate.

5. The method of claim 1 wherein the transmission line is implemented on a PCB board.

6. The method of claim 1 wherein the transmission line is implemented as a co-planar waveguide.

7. The method of claim 1 wherein the transmission line is implemented as a microstrip line.

8. The method of claim 1 wherein the transmission line is implemented as a stripline transmission line.

9. The method of claim 1 wherein the transmission line is implemented as other known transmission line types.

10. The method of claim 1 wherein the said capacitive load is tunable.

11. The method of claim 1 wherein the said parallel capacitive load is tunable.

12. The method of claim 1 wherein the transmission line length is one quarter the wavelength of the wavelength at the resonant frequency.

13. The method of claim 1 wherein the transmission line length is n*lambda+n*lambda/4, where lambda is the wavelength at the resonant frequency.

14. The method of claim 1 wherein the circuit component values satisfy the relationship, 2*pi*fo=1/sqrt(Co*CL*Zo\hat{ }2), where fo is the resonant frequency, Co is said parallel capacitive load value, CL is said capacitive load value, and Zo is the characteristic impedance of said transmission line.
